(19) United States
(12) Patent Application Publication
(10) Pub. No.: US 2023/0321831 A1
(43) Pub. Date: Oct. 12, 2023

(54) Systems and Methods for Model-free Safety Control in Robotics Platforms

(71) Applicant: California Institute of Technology, Pasadena, CA (US)

(72) Inventors: Aaron D. Ames, Pasadena, CA (US); Andrew W. Singletary, Pasadena, CA (US); Tamas Molnar, Pasadena, CA (US)

(73) Assignee: California Institute of Technology, Pasadena, CA (US)

(21) Appl. No.: 18/297,525

(22) Filed: Apr. 7, 2023

Related U.S. Application Data
(60) Provisional application No. 63/328,582, filed on Apr. 7, 2022.
(60) Provisional application No. 63/345,951, filed on May 26, 2022.

(51) Int. Cl. B25J 9/16; B25J 9/12

(52) U.S. Cl. CPC B25J 9/1674; B25J 9/1653; B25J 9/12; B25J 9/161; B25J 9/163

(57) ABSTRACT

Systems and methods for model-free safety control of robotic platforms in accordance with embodiments of the invention are illustrated. One embodiment includes a robot, including a set of one or more actuators, and at least one sensor. The robot further includes a controller including a set of one or more processors and a memory including a controller application, where the controller application configures the set of processors to control the robot by performing the steps of defining a safe set identifying positions where the robot is safe, determining a control barrier function (CBF) based on the safe set, computing a safe velocity based on the CBF and a current position of the robot such that the robot remains in the safe set, and instructing the robot to track to the safe velocity.

### CROSS-REFERENCE TO RELATED APPLICATIONS

The present invention claims priority to U.S. Provisional Patent Application Ser. No. 63/328,582 entitled “Model-Free Safety Regulator” to Singletary et al., filed Apr. 7, 2022, and U.S. Provisional Patent Application Ser. No. 63/345,951 entitled “Control Input Filtering For Safety With Polygon Mesh Representations” to Singletary et al., filed May 26, 2022, the disclosures of which are herein incorporated by reference in its entirety.

### STATEMENT OF FEDERALLY SPONSORED RESEARCH

This invention was made with government support under Grant No. CNS1932091 awarded by the National Science Foundation. The government has certain rights in the invention.

### FIELD OF THE INVENTION

The present invention generally relates to robotics and more specifically to control systems for robots.

### BACKGROUND

The term robotics is often used to refer to the design, manufacture, operation, sensory feedback, and information processing of robots. Robots can take any form, but many robots have taken on appearances similar to humans. Robots are designed to tackle various types of tasks that are dangerous and unsuitable for human. Certain robots perform actions directed by human input, while some robots can operate autonomously by sensing the world around them and making decisions in response to the environment that surrounds them.

Control systems can provide the means to control an output in order to achieve a desired response. There are many ways to classify control systems, including open and closed loop control systems, and continuous time and discrete-time control systems. Closed-loop control systems seek to manage or command the behavior of other devices or systems by incorporating feedback to control one or more outputs of the device or system.

In robotics, control systems can regulate and command the functions of the robot in order to achieve the desired result. The three main components to a robot, including the controller, the sensors, and the actuator(s) can work in a cohesive manner to drive the robot to accomplish its targets or goals. Feedback control systems are typically used as the controller to direct the movements of the robot in an attempt to functions as intended.

### SUMMARY OF THE INVENTION

Systems and methods for model-free safety control of robotic platforms in accordance with embodiments of the invention are illustrated. One embodiment includes a robot, including a set of one or more actuators, and at least one sensor. The robot further includes a controller including a set of one or more processors and a memory including a controller application, where the controller application configures the set of processors to control the robotics platform by performing the steps of defining a safe set identifying positions where the platform is safe, determining a control barrier function (CBF) based on the safe set, computing a safe velocity based on the CBF and a current position of the robot such that the robot remains in the safe set, and instructing the robot to track to the safe velocity.

In another embodiment, the computing of the safe velocity and instructing the actuators to track to the safe velocity are repeated until the robot reaches a target.

In a further embodiment, the computing of the safe velocity includes compute a new safe velocity when the sensor indicates that the robot is approaching a boundary of the safe set such that the velocity is unsafe.

In still another embodiment, the safe set is defined in a configuration space.

In a still further embodiment, the CBF is based on a reduced-order dynamical model of the robot.

In yet another embodiment, the safe velocity is tracked at a rate higher than the rate at which the robot approaches a boundary of the safe set.

In a yet further embodiment, the tracking of the safe velocity is exponentially stable.

In another additional embodiment, the tracking of the safe velocity is input-to-state stable.

In a further additional embodiment, the stability of the tracking satisfies control Lyapunov functions (CLFs).

In another embodiment again, the instructing of the robot to track to the safe velocity includes directing the set of one or more actuators to spin at a rate that drives the platform to track to the safe velocity.

In a further embodiment again, the controller is further configured to define a modified safe set based on CLFs.

In still another embodiment again, the computing of the safe velocity further includes adjusting for errors in continuous approximations of distances.

One embodiment includes a method for model-free safe control of robotics platforms including defining a safe set that represents positions where the robot is safe, determining a control barrier function (CBF) based on the safe set, computing a safe velocity based on the CBF and a current position of the robot such that the robot remains in the safe set, and instructing the robot to track to the safe velocity.

Additional embodiments and features are set forth in part in the description that follows, and in part will become apparent to those skilled in the art upon examination of the specification or may be learned by the practice of the invention. A further understanding of the nature and advantages of the present invention may be realized by reference to the remaining portions of the specification and the drawings, which forms a part of this disclosure.

### BRIEF DESCRIPTION OF THE DRAWINGS

The description and claims will be more fully understood with reference to the following figures and data graphs, which are presented as exemplary embodiments of the invention and should not be construed as a complete recitation of the scope of the invention.

FIG. 1 illustrates a process for model-free control of a robotics platform in accordance with an embodiment of the invention.

FIG. 2 illustrates a platform that can be utilized to implement a model-free safety control system for a robotics platform in accordance with an embodiment of the invention.

FIG. 3 illustrates a model-free safety controller for performing model-free control of a robotics platform in accordance with an embodiment of the invention.

FIGS. 4A-D illustrate a control Lyapunov function (CLF) and a control barrier function (CBF) as well as stable and safe trajectories in accordance with embodiments of the invention.

FIG. 5 illustrates a simulation result of the control of a robotics platform by a model-free safety control system in accordance with an embodiment of the invention.

FIGS. 6A-B illustrates a simulation result of the control of a Ninebot E+ Segway platform by a model-free safety control system and parameters of the platform in accordance with an embodiment of the invention.

FIG. 7 illustrates simulation results for the control of (i) a racing drone by a model-free safety control system and (ii) a quadruped robot by a model-free safety control system in accordance with various embodiments of the invention.

FIG. 8 illustrates a controlled trajectory of robotic manipulator based on a CBF vs desired trajectory in accordance with an embodiment of the invention.

FIG. 9 illustrates an implementation for controlling robotic manipulators in a cooking environment in accordance with an embodiment of the invention.

FIG. 10 illustrates an algorithm for generating safe trajectories, based upon a cache of previously computed reference trajectories in accordance with an embodiment of the invention.

FIG. 11 illustrates a simulated cooking environment where a robotic manipulator is controlled by a model-free safety controller in accordance with an embodiment of the invention.

FIGS. 12A-B illustrate hardware trajectory testing results of a robotic manipulator controlled by a model-free safety controller in a cooking environment in accordance with an embodiment of the invention.

### DETAILED DESCRIPTION

Safety is a fundamental requirement in the control of many different robotics platforms. Therefore, it is important to design a controller that is able to synthesize the appropriate control laws, and provide provable safety guarantees and safety-critical control for robotics platforms. However, synthesizing and implementing the control laws to achieve safety generally require full knowledge of the high-fidelity dynamical models describing the robotics platforms, which is not always possible.

Incorporating safety constraints using quadratic programming and control barrier functions (CBFs) have been a popular approach to ensure safety in recent works. But. CBFs implemented without the full knowledge of the dynamic model of the robotics platform can only guarantee safety kinematically, not dynamically. As constraints are heavily dependent on the dynamic model of the robotics platform, safety cannot be guaranteed with model uncertainty even with the use of CBFs.

Systems and methods in accordance with various embodiments of the invention can tackle this problem by utilizing a model-free safety controller that is capable of stable tracking of a safe velocity to guarantee safety dynamically while having a low dependence on dynamical models. In many embodiments, the model-free safety controller uses one or more CBFs that define safe regions in the configuration space of the robotics platform, and guarantee safety without relying on the full-order dynamics of the robotics platform, which is often not known, or too complex to be used. In classical mechanics, the parameters that define the configuration of a system are called generalized coordinates, and the space defined by these coordinates is called the configuration space of the physical system. In other words, configuration space refers to the space of possible positions that a physical system may attain.

By designing and computing a safe velocity based only on reduced-order kinematics, the method capitalizes on not needing to know the full dynamical model of the robotics platform to incorporate low-level velocity-based tracking within the framework for control. In numerous embodiments, the system tracks the velocity of the robot at a rate that is faster than the rate in which the robot approaches the edges of safe regions. The robotics platform may adjust its velocity accordingly based on the tracking and remain safe.

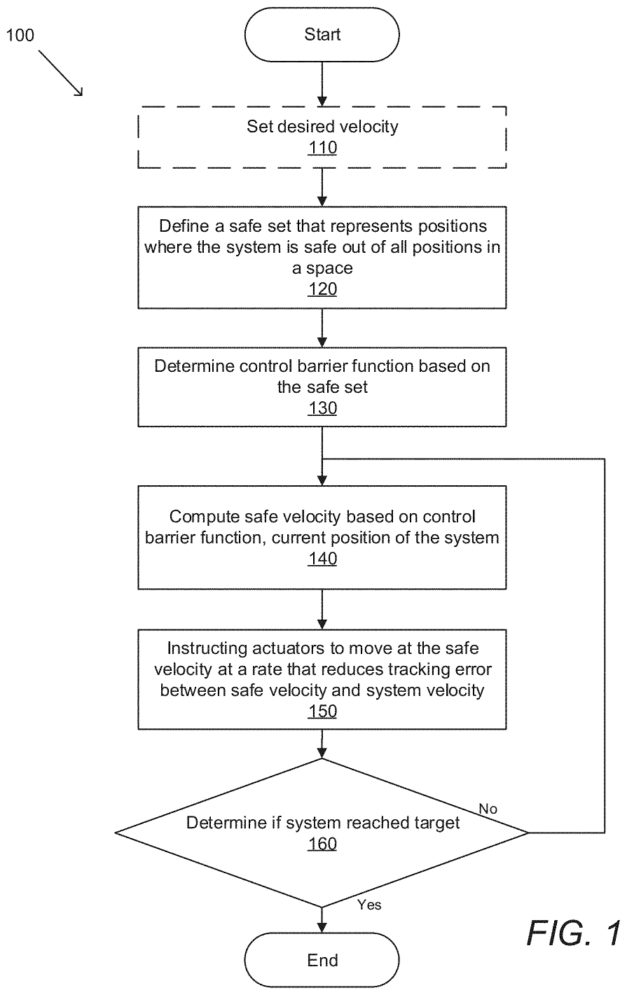

An process for model-free control of a robotics platform in accordance with an embodiment of the invention is illustrated in FIG. 1. Process 100 sets (110) a desired velocity for the robot to move at as the robot moves to a target destination. The desired velocity may be different depending on the type of robotics platform, and may be multi-dimensional depending on the specific configuration of the robotics platform. In some embodiments, the desired velocity may be dependent, on the space in which the robot is operating. As can readily be appreciated, the specific factors that implement the selection of a desired velocity by a model-free control process are largely dependent upon the requirements of specific applications in accordance with various embodiments of the invention.

Process 100 defines (120) a safe set. The safe set may be defined in the configuration space. In several embodiments, the safe set represents positions where the robotics platform is safe out of all positions in a given configuration space. The choice of the safe set may be application-driven, and may represent positions where the robot does not collide with obstacles. Generally in a control-affine system with state space X⊆ [symbol] ⁿ, state x∈X, set of admissible inputs U⊆ [symbol] ^{m}, and control input u∈U:

\dot{x}=f(x)+g(x)u. (1)

the system may be considered safe with respect to S if S is forward invariant under (1), that is, x₀∈S⇒x(t)∈S, ∀t≥0. In other words, the system may be considered safe if its state x(t) is contained in the safe set. S⊂X for all time.

Process 100 determines (130) a control barrier function (CBF) based on the safe set. In many embodiments, CBFs are level-set functions that enable the synthesis and implementation of safety guarantees in controllers. Level set functions are tools for numerical analysis of surfaces and shapes. In the context of CBFs, level set functions can provide information about safety in view of the configuration space and time. In some embodiments, the CBF is determined based on the position of the robot and the position of obstacles in the configuration space. The CBF may be determined based on the position of the robot and the position of the target in the configuration space.

Process 100 computes (140) a safe velocity based on the CBF and the current position of the robot. The safe velocity refers to a speed and direction for the robot to move at such that the robot can reach the target without leaving the safe set, thus ensuring safety. In numerous embodiments, the safe velocity is computed based on reduced-order kinematics. The safe velocity may be re-computed and updated as the robot moves towards the target in order to prevent collision with potential obstacles in the space.

Process 100 instructs (150) the robotics platform to move to the safe velocity. The instructions may command a set of one or more actuators in the robotics platform to move at the safe velocity. In numerous embodiments, the robotics platform moves at the safe velocity by tracking to the computed safe velocity. As the robotics platform moves in the configuration space, safe velocity may be constantly adjusted to ensure safety according to the above definitions. Velocity tracking can become more stable when the tracking error is reduced, meaning that the difference between the platform velocity and the safe velocity can become smaller as the robot moves through a space.

In many embodiments, an exponentially stable velocity tracking controller u=k(q,\dot{q}) is used to reduce the tracking error between platform velocity and safe velocity. In numerous embodiments, the velocity tracking controller aims to achieve exponential stability by reducing tracking errors with each iteration of safe velocity such that the robot can respond more effectively to each computation of the safe velocity, and thereby reducing risks of the robot leaving the safe set. In some embodiments, the velocity tracking controller can reduce the tracking error such that the platform tracks to the safe velocity at a rate higher than the rate at which the platform approaches some boundaries of the safe set. At this tracking rate, the robot may always be able to respond to new safe velocities in a manner that prevents it from leaving the safe set.

Process 100 determines (160) if the robot has reached the target. In the event that the robot is determined to have not reached the target, a new safe velocity may be computed (140) based on the position of the robot, and process 100 may instruct (150) the robotics platform to track to the new safe velocity. This sequence may be iteratively repeated until process 100 determines (160) that the robot has arrived at the target.

While specific processes for model-free safe control of robotics platforms are described above, any of a variety of processes can be utilized to perform model-free safe control of robotics platforms as appropriate to the requirements of specific applications. In certain embodiments, steps may be executed or performed in any order or sequence not limited to the order and sequence shown and described. In a number of embodiments, some of the above steps may be executed or performed substantially simultaneously where appropriate or in parallel to reduce latency and processing times. In some embodiments, one or more of the above steps may be omitted.

### Control Barrier Functions

CBFs can be used as tools to synthesize provably safe controllers. In many embodiments, a continuously differentiable function h: X→ [symbol] is a CBF for the system if there exists α∈ [symbol] _{>0} such that ∀x∈S:

$${sup}_{u ∈ U} \dot{h} ( x , u ) \geq - α h ( x ) , \qquad ( 2 )$$

$$where$$

$$\dot{h} ( x , u ) = ∇ h ( x ) ( f ( x ) + g ( x ) u ) \qquad \text{(3)}$$

is the derivative of h along system (1). With the appropriate CBF synthesized, any locally Lipschitz continuous controller u=k(x) satisfying

\dot{h}(x,k(x))≥−αh(x), (4)

∀x∈S can render (1) safe with respect to S and serve as an appropriate velocity controller for the system.

### Safe Velocity

In a safe robotics platform where its position in the configuration space q lies within a safe set S for all time: q(t)∈S, t≥0, its safe set may be defined as a 0-superlevel set of a continuously differentiable function h: Q→ [symbol] :

S={q∈Q:h(q)≥0}, (5)

where the gradient of h is finite: ∃Cₕ∈ [symbol] _{>0} such that ∥∇h(q)∥≤Cₕ, ∀q∈S, and safety is dependent only on the its position in the configuration space and the CBF is independent of the velocity of the platform. The safe velocity may be computed by satisfying:

∇h(q)\dot{q}ₛ≥−αh(q), (6)

in view of (4), for some α∈ [symbol] _{>0} to be selected. In many embodiments, the safe velocity \dot{q}ₛ depends on the position q, and is a kinematic condition that does not depend on the full-order dynamics.

Under (4), a desired but not necessarily safe controller k_{d}(x) can be modified in a minimally invasive way to a safe controller by solving the quadratic program:

$$k ( x ) = arg {{min}_{u ∈ U} ( u - {k}_{d} ( x ) )}^{⊤} ( u - {k}_{d} ( x ) ) \qquad ( 7 )$$

$$s . t . \dot{h} ( x , u ) \geq - α h ( x ) .$$

### Applying CBFs to Robotic Manipulators

CBFs can also be used as the basis to synthesize a safe controller for robotic manipulators with multiple joints affording it with many degrees of freedom. A CBF may be applied in the controller design for each individual joint in robotic manipulators to ensure its safety. In some embodiments, CBFs can be used to control robotic manipulators whose state x=(q,\dot{q}) consists of the configuration q∈ [symbol] ⁿ and the joint velocities \dot{q}∈ [symbol] ⁿ. For obstacle avoidance, a safe set may be defined over the configuration space as:

S={q∈ [symbol] ⁿ:h(q)≥0}, (8)

where h: [symbol] ⁿ→ [symbol] is continuously differentiable. Similar to modifying the desired velocity into a safe controller in a robotics platform in (7), (4) can be incorporated into a quadratic program to synthesize pointwise optimal and safe controllers for robotic manipulators by minimally modifying a desired but not necessarily safe input u_{des}(x,t)∈U to a safe input u*(x,t)∈U:

$${u}^{*} ( x , t ) = {arg min}_{u ∈ U} {‖ u - {u}_{des} ( x , t ) ‖}^{2} \qquad ( 9 )$$

$$s . t . \dot{h} ( x , u ) \geq - α ( h ( x ) ) .$$

For robotic manipulators with state q, the kinematics can be realized by first considering a system:

\dot{q}=v, (10)

wherein direct control over the joint velocities via the commanded velocity v∈ [symbol] ⁿ may be assumed. A velocity v may be designed by treating it as an input to system (10) and guaranteeing safety by CBFs. Because each joint's velocity is directly controlled according to (10), the quadratic program shown in (9) can be simplified to:

$${v}^{*} ( q , t ) = {arg min}_{v ∈ {R}^{n}} {‖ v - {v}_{des} ( q , t ) ‖}^{2} \qquad ( 11 )$$

$$s . t . ∇ h ( q ) v \geq - α h ( q ) ,$$

where a desired velocity v_{des}(q,t)∈ [symbol] ⁿ can be modified to a safe velocity v*(q,t)∈ [symbol] ⁿ.

### Velocity Tracking in Robotics Platforms

In numerous embodiments, stability of tracking can be achieved using control Lyapunov functions (CLF) and a system equilibrium. In several embodiments, the equilibrium x=0 of system (1) is exponentially stable if there exists a, M, β∈ [symbol] _{>0} such that ∥x₀∥≤a⇒∥x(t)∥≤Me^{-βt}∥x₀∥, ∀t≥0. In some embodiments, a continuously differentiable function V: X→ [symbol] _{≥0} is a CLF for (1) if there exists c, k₁, k₂, λ∈ [symbol] _{>0} such that ∀x∈X:

$${k}_{1} {‖ x ‖}^{c} \leq V ( x ) \leq {k}_{2} {‖ x ‖}^{c} \qquad ( 12 )$$

$${inf}_{u ∈ U} \dot{V} ( x , u ) \leq - λ V ( x ) ,$$

$$where$$

$$\dot{V} ( x , u ) = ∇ V ( x ) ( f ( x ) + g ( x ) u ) \qquad \text{(13)}$$

is the derivative of V along system (1). Hence, any locally Lipschitz continuous controller u=k(x) satisfying

\dot{V}(x,k(x))≤−λV(x), (14)

∀x∈X renders x=0 exponentially stable. In many embodiments, synthesizing a control input u while enforcing condition (14) achieves exponential stability.

For robotics platforms with configuration space Q⊆ [symbol] ⁿ, configuration coordinates q∈Q, set of admissible inputs U⊆ [symbol] ⁿ, control input u∈U, and dynamics:

D(q)\ddot{q}+C(q,\dot{q})\dot{q}+G(q)=Bu, (15)

where D(q)∈ [symbol] ^{n×n} is the inertia matrix, C(q,\dot{q})∈ [symbol] ^{n×n} contains centrifugal and Coriolis forces, G(q)∈ [symbol] ⁿ involves gravity terms and B∈ [symbol] ^{n×m} is the input matrix. D(q) is symmetric, positive definite, \dot{D}(q,\dot{q})−2C(q,\dot{q}) is skew-symmetric. Control laws can be selected as k: Q× [symbol] ⁿ→ [symbol] ^{m}, u=k(q,\dot{q}), initial conditions q(0)=q₀, \dot{q}(0)=\dot{q}₀, and assume that a unique solution q(t) exists for all t≥0.

The tracking error may be defined as:

ė=\dot{q}−\dot{q}ₛ. (16)

In numerous embodiments, the velocity tracking controller u=k(q,\dot{q}) achieves exponentially stable tracking by reducing the tracking error as t increases: ∥ė(t)∥≤M∥ė₀∥e^{-λt} for some M, λ∈ [symbol] _{>0}. In other words, if ė is differentiable (ë, \ddot{q}ₛ exist), there exists a continuously differentiable Lyapunov function V: Q× [symbol] ⁿ→ [symbol] _{≥0} such that ∀(q,ė)∈Q× [symbol] ⁿ:

k₁∥ė∥≤V(q,ė)≤k₂∥ė∥, (17)

for some k₁, k₂∈ [symbol] _{>0}, and there exists λ∈ [symbol] _{>0} such that ∀(q,ė,\dot{q},\ddot{q}ₛ)∈Q× [symbol] ⁿ× [symbol] ⁿ× [symbol] ⁿ u satisfies:

\dot{V}(q,ė,\dot{q},\hat{q}ₛ,u)≤−λV(q,ė), (18)

in view of (14).

In numerous embodiments, tracking the safe velocity can achieve safety for the full dynamics if parameter a is selected to be small enough. Specifically, for tracking controllers satisfying (17) and (18), stability may translate into safety for the full system (15) if λ>α. Safety guarantees provided by velocity tracking may be ensured by having λ>α, where safety can be achieved such that (q₀,ė₀)∈S_{V}⇒q(t)∈S, ∀t≥0, and a modified safe set can be generated where:

S_{V}={(q,ė)∈Q× [symbol] ⁿ:h_{V}(q,ė)≥0},

h_{V}(q,ė)=−V(q,ė)+αₑh(q), (19)

with αₑ=(λ−α)k₁/Cₕ>0 and Cₕ, k₁ defined at (5, 17), in view of system (15), safe set (5), safe velocity satisfying (6), and velocity tracking controller satisfying (18).

In many embodiments, condition λ>α means the controller tracks the safe velocity fast enough (characterized by λ) compared to how fast the boundary of the safe set may be approached (characterized by α). A small enough a may be chosen for a given velocity tracking controller, for example, by gradually increasing α from 0. The existence of such α can be guaranteed by the method. In selected embodiments, smaller α may cause the platform to be more conservative, evolving farther from the boundary of the safe set.

Condition (6) is equivalent to designing a safe control input \dot{q}ₛ for a single integrator system \dot{q}=\dot{q}ₛ, making this approach is a manifestation of control based on reduced-order models. While h is a CBF for the reduced-order model, h_{V} may be a CBF for the full system (15) as a dynamic extension of h. Other reduced-order models of the form \dot{q}=A(q)μₛ with control input μₛ∈ [symbol] ^{k} and transformation A(q)∈ [symbol] ^{n×k} can also be used. In some embodiments, other reduced-order models include the unicycle model for wheeled robots with q=(x,y,ψ)∈ [symbol] ³ containing Cartesian positions and yaw angle and μₛ=(vₛ,ωₛ)∈ [symbol] ² containing forward velocity and yaw rate:

$$[ \begin{matrix}\dot{x} \\ \dot{y} \\ \dot{ψ}\end{matrix} ] = [ \begin{matrix}cos ψ & 0 \\ sin ψ & 0 \\ 0 & 1\end{matrix} ] [ \begin{matrix}{v}_{s} \\ {ω}_{s}\end{matrix} ] . \qquad ( 20 )$$

The safe velocity μₛ is given by ∇h(q)A(q)μₛ≥−αh(q) based on (6), and the proof of (19) holds with substitution \dot{q}ₛ=A(q)μₛ. The tracking controller u, however, must provide property (18) with respect to ė=\dot{q}−A(q)μₛ.

In practice, robotics platforms may be subject to unknown disturbances that may compromise stability or safety. For example, a bounded disturbance d∈ [symbol] ^{m} added to the input a can lead to the system \dot{x}=f(x)+g(x)(u+d). To address disturbances, the notion of exponential stability can be extended to exponential input-to-state stability (ISS). In many embodiments, a class- [symbol] function μ such that ∥x₀∥≤a⇒∥x(t)∥≤Me^{-βt}∥x⁰∥+μ(∥d∥_{∞}), ∀t≥0 may be utilized by a controller. Instead of achieving stability by converging to x=0, solutions may converge to a neighborhood of the origin which depends on the size of the disturbance. In selected embodiments, exponential ISS is achieved by strengthening (14) to:

\dot{V}(x,u,d)≤−λV(x)+i(∥d∥_{∞}), (21)

for some class- [symbol] function i.

Applying the above considerations to (15), where ideal exponential tracking of the safe velocity is not possible, disturbance can be captured via a bounded input disturbance d that represents the effect of imperfect tracking controllers, time delays or modeling errors. Then, instead of safety, the system may guarantee input-to-state safety (ISSf), i.e., the invariance of the larger set S_{d}⊇S:

S_{d}={q∈Q:h_{d}(q)≥0},

h_{d}(q)=h(q)+γ(∥d∥_{∞}), (22)

where γ is a class- [symbol] function to be specified. A dynamic extension S_{Vd}⊇S_{V} of set S_{d} may be introduced:

S_{Vd}={(q,ė)∈Q× [symbol] ⁿ:h_{Vd}(q,ė)≥0},

h_{Vd}(q,ė)=h_{V}(q,ė)+γ(∥d∥_{∞}). (23)

ISSf may be guaranteed by input-to-state stable (ISS) tracking: ∥ė(t)∥≤M∥ė₀∥e^{-λt}+μ(∥d∥_{∞}). When the tracking is poor, μ(∥d∥_{∞}) may dominate this bound. If the error does not decay (M=0), the bound may be reduced to ∥ė(t)∥≤∥ė∥_{∞} and the traditional ISSf guarantees can be recovered. For ISS, instead of (18) the tracking controller may satisfy:

\dot{V}(q,ė,\dot{q},\hat{q}ₛ,u,d)≤−λV(q,ė)+i(∥d∥_{∞}), (24)

for some class- [symbol] function i. For system (15), sets S_{d} and S_{Vd} in (22) and (23), safe velocity satisfying (6), and velocity tracking controller satisfying (24), if λ>α, input-to-state safety may be achieved such that (q₀, ė₀)∈S_{Vd}⇒q(t)∈S_{d}, ∀t≥0, where αₑ is given in (19) and γ(∥d∥_{∞})=i(∥d∥_{∞})/α.

Similarly, disturbances may be accounted for in defining safety. Safety can be extended to ISSf by requiring that the system stays within a neighborhood S_{d}⊇S of the safe set S which depends on the size of the disturbance: x₀∈S_{d}⇒x(t)∈S_{d}, ∀t≥0. This neighborhood can be defined as a 0-superlevel set:

S_{d}={x∈X:h(x)+γ(∥d∥_{∞})≥0}, (25)

with some class- [symbol] function γ. ISSf may be guaranteed by replacing (4) with:

\dot{h}(x,u,d)≥−αh(x)−i(∥d∥_{∞}), (26)

for some class- [symbol] function i.

### Velocity Tracking in Robotic Manipulators

In robotic manipulators with full-order dynamics similar to (15), tracking error for a velocity command v*(q,t) may be defined as

ė=\dot{q}−v*, (27)

and exponentially stable tracking assumed. A low-level controller u=k(x,t) may exist for the control system (1) obtained from (15) such that

∥ė(t)∥≤M∥ė₀∥e^{-λt} (28)

holds for some M, λ>0 along the solution x(t) of a closed-loop system

\dot{x}=f_{cl}(x):=f(x)+g(x)k(x). (29)

with q(t₀)=q₀, \dot{q}(t₀)=\dot{q}₀ and ė(t₀)=ė₀.

For the full-order dynamics of a robot manipulator (15) expressed as the control system (1), and the safe set S in (8), there may exist. Cₕ>0 s.t. ∥∇h(q)∥≤Cₕ for all q∈S assuming that h has bounded gradient. In some embodiments, v*(q,t) may be the safe velocity given by the quadratic program (11), with corresponding error in (27). Safety can be achieved for the full-order dynamics (15) in that:

$$( {q}_{0} , {\dot{e}}_{0} ) ∈ {S}_{M} ⇒ q ( t ) ∈ S , ∀ t \geq {t}_{0} , \qquad ( 30 )$$

$$where :$$

$${S}_{M} = \{ ( q , \dot{e} ) ∈ {}^{2 n} : h ( q ) - \frac{{C}_{h} M}{λ - α} ‖ \dot{e} ‖ \geq 0 \} . \qquad ( 31 )$$

if (29) holds with λ>α. With robotic manipulators, CLFs may not be needed to achieve exponential tracking, and a modified safe set can be constructed with easier-to-identify terms.

In order to prevent collisions with the environment, any point on the robotic manipulators should avoid coining into contact with any point in the environment. Denoting the set of all points on the robot as A⊂ [symbol] ³, and the set of all points in the collision environment as B⊂ [symbol] ³, A∩B=Ø is required to guarantee safety where distance(A,B)>0. More formally, distance may be defined as:

$$distance ( A , B ) = {inf}_{\begin{matrix}{p}_{A} ∈ A \\ {p}_{B} ∈ B\end{matrix}} ‖ {p}_{A} - {p}_{{B}_{2}} ‖ , \qquad ( 32 )$$

which can be computed in [symbol] ³ using the Gilbert-Johnson-Keerthi (GJK) algorithm.

In many embodiments, it is advantageous to define a CBF that is negative in the event of collision, since CBFs may also ensure that the boundary of the set S is re-approached if h(x)<0. In collision, penetration is defined as:

$$penetration ( A , B ) = {inf}_{\begin{matrix}{p}_{A} ∈ A \\ {p}_{B} ∈ \overline{B}\end{matrix}} ‖ {p}_{A} - {p}_{{B}_{2}} ‖ , \qquad ( 33 )$$

where B̅ is the complement of B, or the set of points outside the collision scene. Penetration can be computed using the Expanding Polytope Algorithm (EPA).

The combination of GJK and EPA algorithms can form the notion of signed distance, which may be denoted by:

sd(A,B)=distance(A,B)−penetration(A,B). (34)

When the points p_{A} and p_{B} of the robot and the environment are given in local coordinates, the following expression can be utilized to compute the signed distance:

$${sd}_{AB} ( q ) = {max}_{\begin{matrix}\tilde{n} ∈ {ℝ}^{3} \\ ‖ {\tilde{n}}_{2} ‖ = 1\end{matrix}} {min}_{\begin{matrix}{p}_{A} ∈ A \\ {p}_{B} ∈ B\end{matrix}} \tilde{n} \cdot ( {F}_{A}^{W} ( q ) {p}_{A} - {F}_{B}^{W} {p}_{B} ) , \qquad ( 35 )$$

where F_{A}^{W}(q)∈ [symbol] ^{3×3} gives the pose of the robot in a space that depends on the configuration q, and F_{B}^{W}∈ [symbol] ^{3×3} gives the pose of the collision environment, i.e., F_{A}^{W}(q)p_{A} and F_{B}^{W}p_{B} indicate points in the space.

With the signed distance, CBF:

h(q)=sd_{AB}(q), (36)

which defines the corresponding safe set of the system:

S={q∈ [symbol] ⁿ:h(q)=sd_{AB}(q)≥0}. (37)

can be considered. Based on (35), h can be written as:

h(q)=\hat{n}(q)^{T}(F_{A}^{W}(q)\hat{p}_{A}(q)−F_{B}^{W}\hat{p}_{B}(q)). (38)

Here, \hat{n}(q) and \hat{p}_{A}(q), \hat{p}_{B}(q) denote the direction and points that maximize and minimize the expression in (35), respectively, which may depend on the configuration q.

It is important to note that in Euclidean space, signed distance, h, may be differentiable almost everywhere, and satisfies

$${‖ \frac{\partial h}{\partial {p}_{A}} ‖}_{2} = 1.$$

A set of measure zero where ∂h/∂q is discontinuous may exist, since functions \hat{n} and \hat{p}_{A}, \hat{p}_{B} are nonsmooth due to the max and min operators in (35). In many embodiments, nonsmoothness in operation may be resolved under the following framework. First, the gradient of h may be expressed as follows:

$$\frac{\partial h}{\partial q} = {\hat{n} ( q )}^{T} {J}_{A} ( q ) + δ ( q ) ,$$

where

$${J}_{A} ( q ) = \frac{\partial {F}_{A}^{W}}{\partial q} {\hat{p}}_{A} ( q )$$

and δ(q) are the remainder terms associated with the derivatives of \hat{n}, \hat{p}_{A}, and \hat{p}_{B}. \hat{n}(q)^{T}J_{A}(q) may be continuous, while δ(q) is discontinuous on a set of measure zero. The term \hat{n}(q)^{T}J_{A}(q) can be interpreted as a continuous approximation of ∂h/∂q, while the approximation error δ(q) may act as disturbance. The size of the disturbance can be characterized by its essential supremum:

$${‖ δ ‖}_{∞} := {ess sup}_{t \geq {t}_{0}} {‖ δ ( q ( t ) ) ‖}_{2} ,$$

where the function δ is essentially bounded if ∥δ(t)∥₂ is bounded by a finite number for almost all t≥t₀ (i.e., ∥δ(t)∥₂ is bounded except on a set of measure zero). The quantity ∥δ∥_{∞} can then be defined as the least such bound. The points where h is not differentiable and δ is discontinuous may occur on a set of measure zero, and therefore do not impact the essential supremum. In several embodiments, the continuous approximation \hat{n}(q)^{T}J_{A}(q) in (39) is incorporated into the control design. The following result can demonstrate that this approximation is sufficient to maintain safety if the disturbance δ(q) is properly accounted for in an ISSf context.

In many embodiments, the controller for the kinematic model of a robotic manipulator with system (10) may be expressed as the quadratic program:

$${v}^{*} ( q , t ) = {argmin}_{v ∈ {R}^{n}} {‖ v - {v}_{des} ( q , t ) ‖}_{2}^{2} \\ s . t . {\hat{n} ( q )}^{T} {J}_{A} ( q ) v \geq - α h ( q ) + 2 {J}_{max} {\dot{q}}_{max} , \qquad ( 40 )$$

with \dot{q}ₘₐₓ=∥\dot{q}∥_{∞} and Jₘₐₓ= [symbol] ∥J_{A}(q)∥₂, and can render the set S in (37) forward invariant for the resulting closed-loop system. Therefore, in numerous embodiments, the controller (40) keeps system (10) safe. As such, collision-free behavior can be enforced for the kinematic model of the robotic manipulator, since the disturbance in (39) is handled by the last term of (40). The feasibility of (40) in singular configurations can be guaranteed by increasing a or decreasing \dot{q}ₘₐₓ by reducing the desired speed.

Another type of collision that the robotic manipulator may seek to avoid is self-collision. Self-collisions are defined as collisions between any two links of the robot that may not be explicitly allowed to collide. In many embodiments, the signed distance function may still be used, but now F_{B}^{W} may also depend on the configuration q:

$${sd}_{AB} ( q ) = {max}_{\begin{matrix}\tilde{n} ∈ {ℝ}^{3} \\ ‖ {\tilde{n}}_{2} ‖ = 1\end{matrix}} {min}_{\begin{matrix}{p}_{A} ∈ A \\ {p}_{B} ∈ B\end{matrix}} \tilde{n} \cdot ( {F}_{A}^{W} ( q ) {p}_{A} - {F}_{B}^{W} ( q ) {p}_{B} ) . \qquad ( 41 )$$

Thus, the gradient of h(q)=sd_{AB}(q) may be represented by:

$$\frac{\partial h}{\partial q} = {\hat{n} ( q )}^{T} ( {J}_{A} ( q ) - {J}_{B} ( q ) ) + δ ( q ) . \qquad ( 42 )$$

(40) can be applied to self-collisions, with slight modifications, which results in the quadratic system:

$${v}^{*} ( q , t ) = {argmin}_{v ∈ {R}^{n}} {‖ v - {v}_{des} ( x , t ) ‖}_{2}^{2} \\ s . t . {\hat{n} ( q )}^{T} ( {J}_{A} ( q ) - {J}_{B} ( q ) ) v \geq - α h ( q ) + 4 {J}_{max} {\dot{q}}_{max} . \qquad ( 43 )$$

Inherent error in the form of disturbance may be accounted for in approximating distance computations even without knowing the exact gradient of the distances between the two objects in the space in time.

In some embodiments, the full-order dynamics of a robot manipulator (15) is expressed as the control system (1), and the safe set S in (37) associated with the signed distance sd_{AB}(q) between the robot and the environment in (35), where v*(q,t) is the safe velocity given by the quadratic program (40), with corresponding error in (27). In many embodiments, a modified safe set is created for the full-order dynamics (15) in that:

$$( {q}_{0} , {\dot{e}}_{0} ) ∈ {§}_{M} q ( t ) ∈ S , ∀ t \geq {t}_{0} , \qquad ( 44 )$$

$$where :$$

$${S}_{M} = \{ ( q , \dot{e} ) ∈ {ℝ}^{2 n} : {sd}_{AB} ( q ) - \frac{{J}_{max} M}{λ - α} {‖ \dot{e} ‖}_{2} \geq 0 \} , \qquad ( 45 )$$

if (28) holds with λ>α such that the controller achieves exponential tracking.

In many embodiments, the selection of α satisfies λ>α. The same safety guarantees can be stated for self-collision avoidance with the quadratic program (43), and changing environments can be treated similarly if the resulting safe velocity is tracked well. Moreover, a practical advantage of this approach is that robust tracking can yield safety robust to those disturbances. Model-free safe controllers that can be utilized to assist with the control of robotics platforms including (but not limited to) robotics platforms that incorporate manipulators in accordance with various embodiments of the invention are discussed further below.

### Robotics Platforms Incorporating Model-Free Safe Controllers

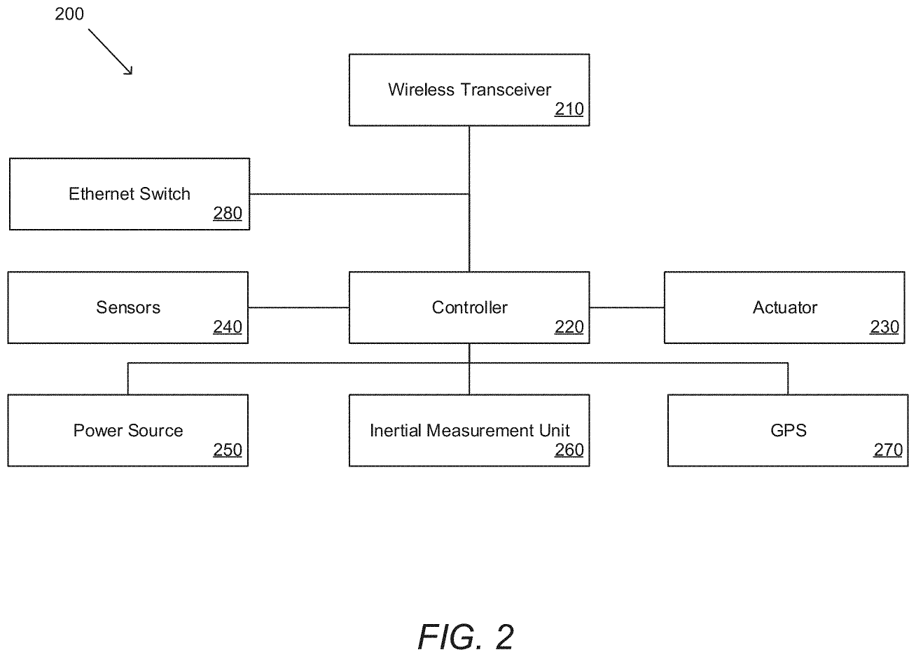

A robotics platform that incorporates a model-free controller in accordance with an embodiment of the invention is illustrated in FIG. 2. The robotics platform 200 may include a wireless transceiver 210. In many embodiments, the wireless transceiver 210 is used for receiving instructions externally and sending feedback data to external processing devices. Controller 220 may be configured to act as a model-free safe controller capable of computing a safe velocity and guide the platform from a starting position to a target while tracking to the safe velocity. Controller 220 may command a set of one or more actuators 230 in velocity tracking. In a number of embodiments, the set of one or more actuators 230 may connect to different types of limbs, including but not limited to wheels, robotic limbs, and propellers. Actuators 230 may convert power provided from power source 250 to facilitate movement in the type of limbs that are connected to the actuators.

In some embodiments, platform 200 includes at least one sensor 240. Sensors 240 may be used by the robotics platform to detect surrounding obstacles and help with collision avoidance. Platform 200 may include an inertial measurement unit (IMU) 260 and a GPS 270 to assist the platform with positioning in multi-dimensional space. Platform 200 may include an ethernet switch 280. Data transmitted and received by wireless transceiver 210 may similarly be transmitted and received using the ethernet switch 280.

In several embodiments, platform 200 includes multiple controllers 220, which can include multiple model-free safe controllers that can receive inputs from other controllers and/or the at least one sensor directly. Model-free safe controllers can provide one or more outputs to a primary control system for platform 200.

Although a specific example of a robotics platform is illustrated in this figure, any of a variety of robotics platforms can be utilized to perform model-free controls similar to those described herein as appropriate to the requirements of specific applications in accordance with embodiments of the invention.

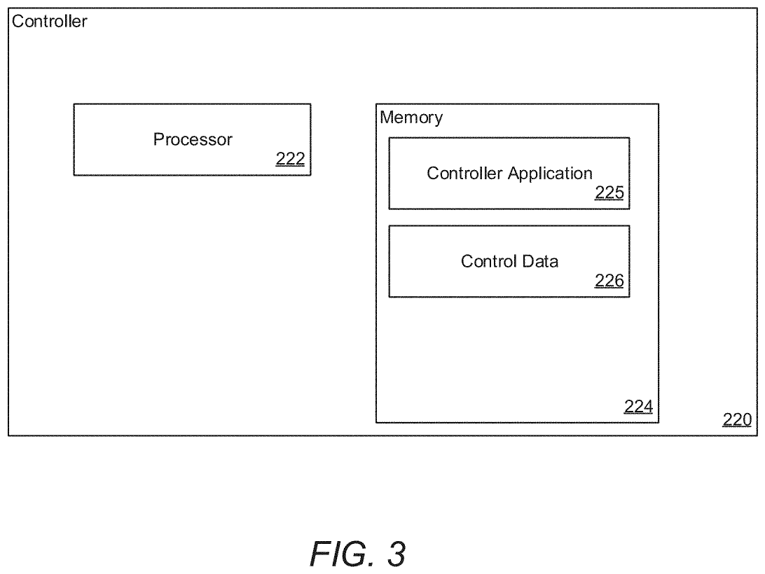

An model-free safe controller for performing model-free control of a robotics platform in accordance with an embodiment of the invention is illustrated in FIG. 3. In numerous embodiments, controller 220 includes a set of one or more processors 222. Processors 222 can perform velocity tracking and velocity adjustments for the robotics platform to move to the target. Controller 220 may include a memory 224, which stores a controller application 225. In several embodiments, controller application 225 directs processors 222 to perform the velocity tracking and adjustments. Memory 224 may include a storage for control data 226. Control instructions including safe velocity may be included in control data storage 226. Platform 200 may receive safe velocity that is computed remotely as well as control instructions from an external device. These control data received externally can be stored in control data storage 226.

Although specific examples of model-free safe controllers are described above with reference to FIG. 3, any of a variety of model-free safe controllers can be utilized to perform model-free control of robtics platforms similar to those described herein as appropriate to the requirements of specific applications in accordance with embodiments of the invention.

### Simulation and Results

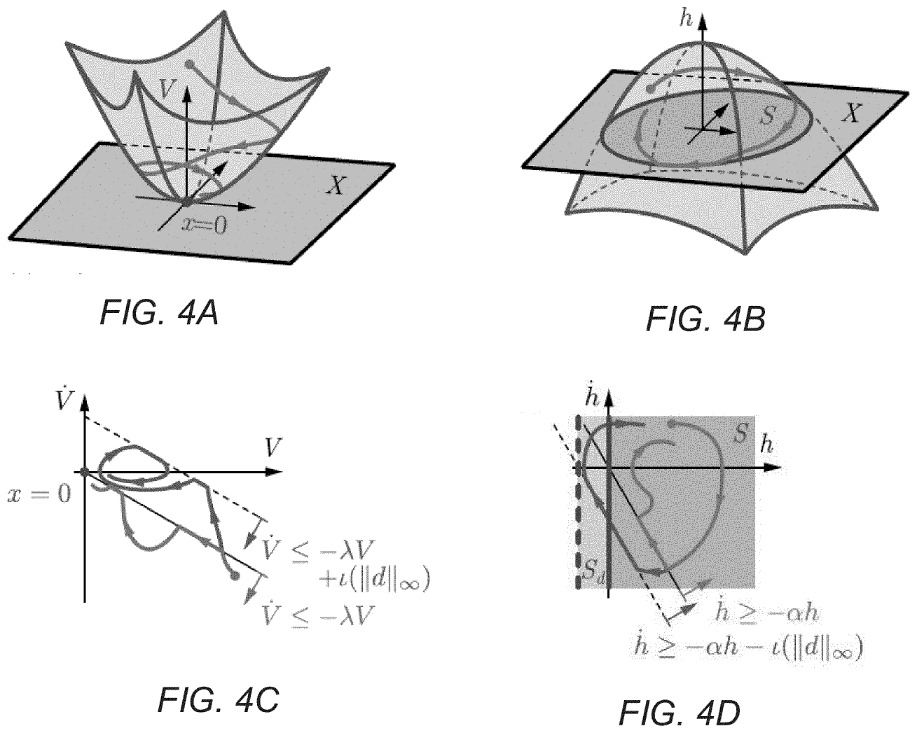

FIGS. 4A-D demonstrates examples of CLFs and CBFs as well as stable and safe trajectories. FIG. 4A illustrates a CLF and a stable trajectory that can enable a model-free safe controller to reach equilibrium at x=0. FIG. 4B illustrates a CBF based on a defined safe set. While V is nonnegative, h may take any value. A safe trajectory for the system always stays inside the safe set. FIG. 4C illustrates the stability condition (14) and a stable trajectory (lower curve), the ISS condition (21) and an input-to-state stable trajectory (upper curve). To achieve ISS, the trajectory converges to a neighborhood of x=0. FIG. 4D illustrates the safety condition (4) and a safe trajectory (left), the ISSf condition (26) and an input-to-state safe trajectory (right). To achieve ISSf, a superset. S_{d} of S is forward invariant.

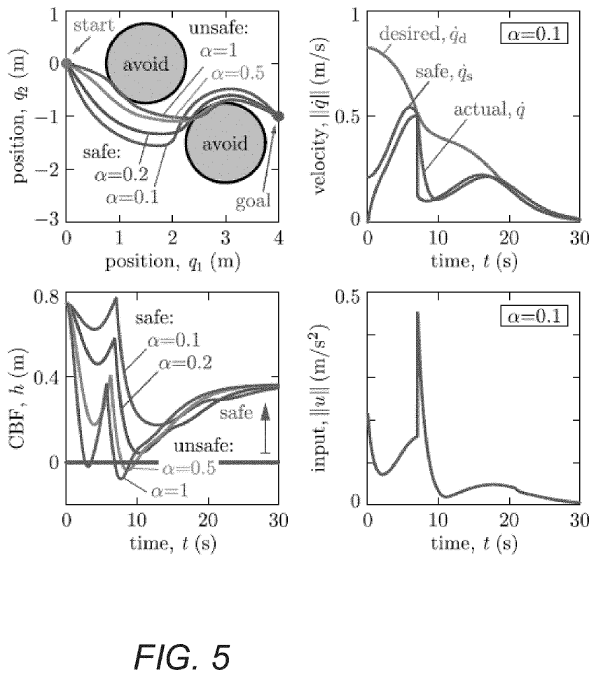

FIG. 5 illustrates a simulation result of model-free safety control in a robotics platform in accordance with an embodiment of the invention. The simulation was performed with a double integrator system in two dimensions where:

\ddot{q}=u, (46)

where q∈ [symbol] ² is the planar position of the robot and u∈ [symbol] ². A simple solution can be to realize the desired velocity \dot{q}_{d}=−K_{P}(q−q_{g}) that is based on a proportional controller with gain K_{P}∈ [symbol] _{>0}. An obstacle of radius r centered at qₒ can be avoided with the help of the distance d=∥q−qₒ∥ and the CBF:

h(q)=d−r, (47)

with gradient ∇h(q)=(q−qₒ)^{T}/∥q−qₒ∥=nₒ^{T} equal to the unit vector nₒ pointing from the obstacle to the robot. Then, the safe velocity can be found by using condition (6). Specifically, the desired velocity \dot{q}_{d} was modified in a minimally invasive fashion by solving the quadratic program:

$$arg {{min}_{{\dot{q}}_{s} ∈ {ℝ}^{2}} ( {\dot{q}}_{s} - {\dot{q}}_{d} )}^{T} ( {\dot{q}}_{s} - {\dot{q}}_{d} ) \\ s . t . {n}_{o}^{T} {\dot{q}}_{s} \geq - α ( d - r ) , \qquad ( 48 )$$

in view of (7). Based on the Karush-Kuhn-Tucker conditions, it has the solution:

\dot{q}ₛ=\dot{q}_{d}+max{−nₒ^{T}\dot{q}_{d}−α(d−r),0}nₒ. (49)

The safe velocity can be tracked for, by way of example, the controller u=−K_{D}(\dot{q}−\dot{q}ₛ) with gain K_{D}∈ [symbol] _{>0}.

FIG. 5 illustrates four simulation results for avoiding two obstacles with parameters K_{P}=0.2 s⁻¹, K_{D}=1 s⁻¹ and α=0.1, 0.2, 0.5 and 1 s⁻¹, respectively. With the proposed approach, the double integrator system avoids the obstacles, although the second-order dynamics was not directly taken into account during the CBF and control design. The condition for safety, however, is picking a small enough a value (e.g., 0.1 or 0.2), while safety is violated for larger α (e.g., 0.5 or 1). Accordingly, the safe velocity \dot{q}ₛ is only piecewise differentiable; for simplicity, our constructions are restricted to the differentiable segments.

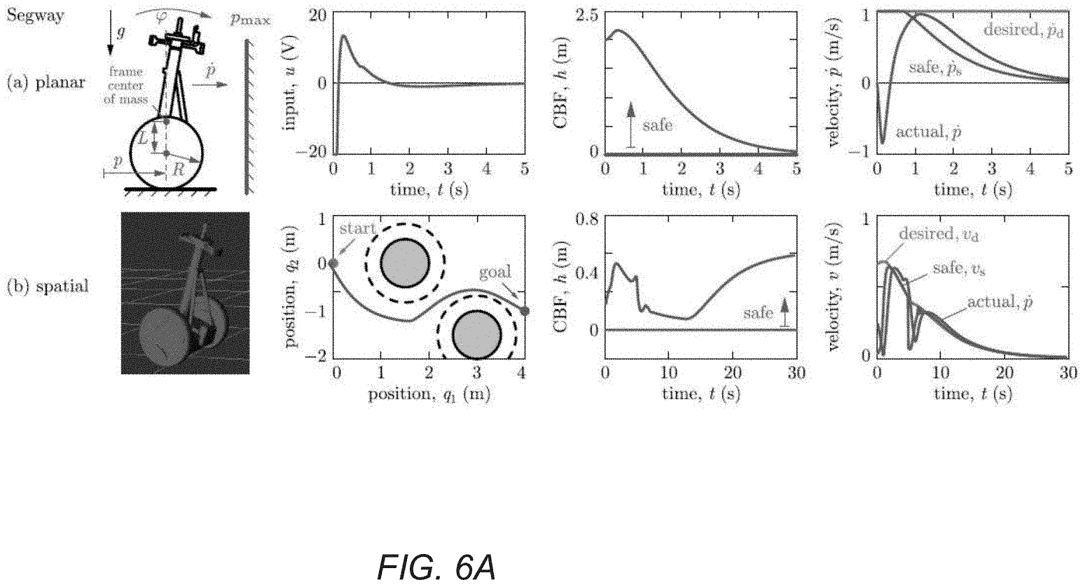

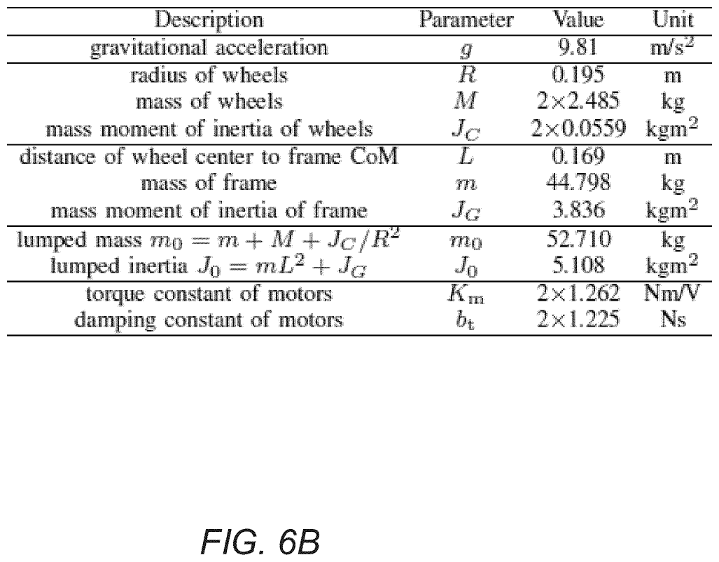

FIG. 6A illustrates simulation results for a Ninebot E+ Segway robotics platform incorporating a model-free safe controller in accordance with an embodiment of the invention. For the two-degrees of freedom planar Segway model in FIG. 6A with configuration q=[p, φ]^{T}∈Q= [symbol] ×[0, 2π] including the position p and pitch angle φ, the dynamics are in form (15), where:

$$D ( q ) = [ \begin{matrix}{m}_{0} & m L cos φ \\ m L cos φ & {J}_{0}\end{matrix} ] , G ( q ) = [ \begin{matrix}0 \\ - mgL sin φ\end{matrix} ] , \\ C ( q , \dot{q} ) = [ \begin{matrix}{b}_{t} / R & - {b}_{t} - m L \dot{φ} sin φ \\ - {b}_{t} & {b}_{t} R\end{matrix} ] , B = [ \begin{matrix}{K}_{m} / R \\ - {K}_{m}\end{matrix} ] . \qquad ( 50 )$$

The parameters of the Segway model are illustrated in FIG. 6B with u∈U=[−20,20] V.

The simulation included setting a desired forward velocity \dot{p}_{d} until reaching a wall at position pₘₐₓ, then stopping automatically and safely in front of the wall. This is captured by the CBF:

h(q)=pₘₐₓ−p, (51)

which, by condition (6), leads to the safe forward velocity:

\dot{p}ₛ=min{\dot{p}_{d},α(pₘₐₓ−p)}, (52)

similar to (49). This safe velocity is tracked by the controller:

u=K_{\dot{p}}(\dot{p}−\dot{p}ₛ)+K_{φ}φ+K_{\dot{φ}}\dot{φ} (53)

with K_{\dot{p}}=50 Vs/m, K_{φ}=150 V/rad, K_{\dot{φ}}=40 Vs/rad, which also stabilizes the Segway to the upright position.

FIG. 6A shows simulation results where the Segway executes the task starting from p₀=0, φ₀=−0.138 rad (where its frame is vertical), \dot{p}₀=0, \dot{φ}₀=0, for \dot{p}_{d}=1 m/s, pₘₐₓ=2 m and α=0.5 s⁻¹. Notice that controller (52, 53) is model-free, it does not rely on the full dynamics (15, 50). The gains K_{\dot{p}}, K_{φ} and K_{\dot{φ}}, however, are tuned so that the full dynamics achieves stable velocity tracking. These gains were tuned based on linearization and LQR and they determine the tracking performance with the associated A.

For the spatial model of the Segway in FIG. 6A with 7-dimensional state space and 2 control inputs. The simulation included navigating the Segway from a start point to a goal (left panel) while avoiding obstacles of radius 0.5 m. The obstacle radius is buffered by the size of the Segway (dashed circle) and the Segway's center must be kept outside this zone. This task is accomplished by tracking a safe velocity obtained for the unicycle model (20). The desired forward velocity and yaw rate were set at μ_{d}=(v_{d},ω_{d}) based on the distance d_{g}=∥(x_{g}−x,y_{g}−y)∥ to the goal as v_{d}=Kᵥd_{g} and ω_{d}=−K_{ω}(sin ψ−(y_{g}−y)/d_{g}). To avoid obstacles, a CBF that includes the heading direction was used:

h(q)=d−r−δ cos(ψ−θ), (54)

where d=∥(xₒ−x,yₒ−y)∥ is the distance from the obstacle, θ=arctan((yₒ−y)/(xₒ−x)) is the angle towards the obstacle, and δ∈ [symbol] _{>0} is a tunable parameter.

This CBF is incorporated into the quadratic program:

$$arg {{min}_{{μ}_{s} ∈ {ℝ}^{2}} ( {μ}_{s} - {μ}_{d} )}^{T} ( {μ}_{s} - {μ}_{d} ) \\ s . t . ∇ h ( q ) A ( q ) {μ}_{s} \geq - α h ( q ) , \qquad ( 55 )$$

ef. (48), where Γ=diag{1, R²} is a weight between forward velocity and yaw rate with parameter R∈ [symbol] _{>0}. The resulting safe velocity μₛ=(vₛ,ωₛ) is tracked by the controller:

u_{1,2}=K_{\dot{p}}(\dot{p}−vₛ)+K_{φ}φ+K_{\dot{φ}}\dot{φ}±K_{\dot{ψ}}(\dot{ψ}−ωₛ) (56)

used at the two wheels with the same gains as the Segway in plane and a gain K_{\dot{ψ}}=10 Vs/rad on the yaw rate \dot{ψ}. With this approach, the Segway is able to move to the goal safely, while its controller (55, 56) is model-free. FIG. 6A shows the safe motion for Kᵥ=0.16 s⁻¹, K_{ω}=0.8 s⁻¹, α=0.2 s⁻¹, δ=0.5 m and R=0.25 m.

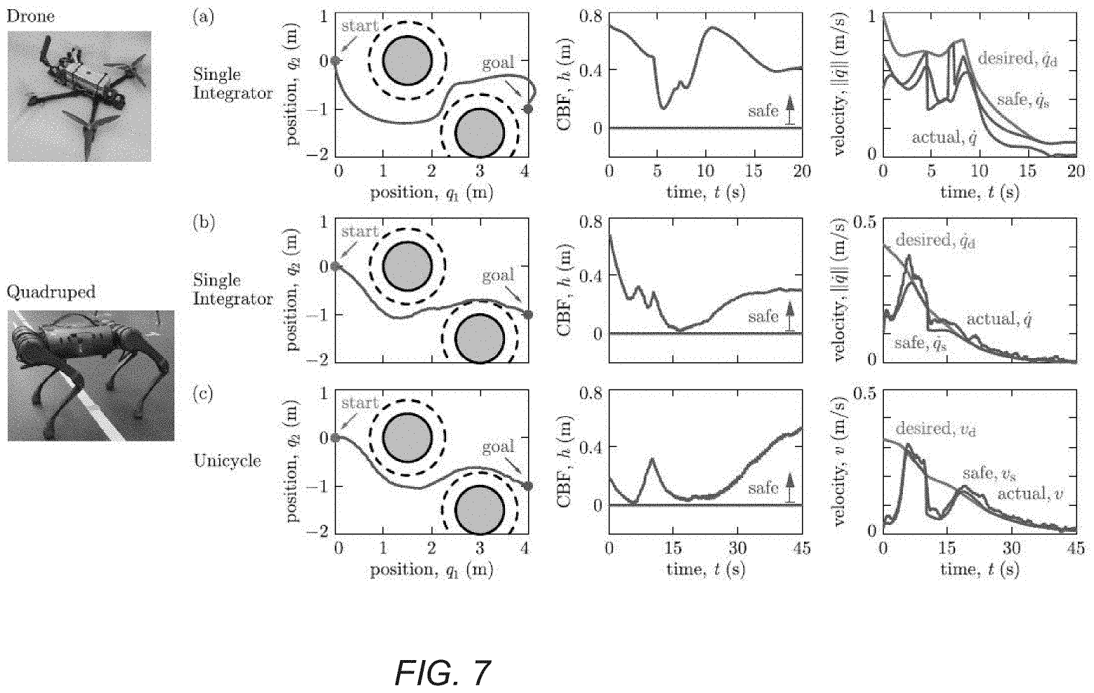

FIG. 7 illustrates the simulations results for model-free safe controllers implemented on a racing drone and a quadruped. The same obstacle avoidance task was simulated on two fundamentally different hardware platforms: a Drone and a Quadruped. The obstacle locations were known to the robots, sensory information was used to determine the robots' position only. Two classes of experiments were performed: by synthesizing safe velocities based on the single integrator and unicycle models.

First, the associated safe velocity with the Drone and Quadruped were tracked with the single integrator model by platform-specific tracking controllers. CBF (47) and safe velocity (49) were used. The desired velocity was \dot{q}_{d}=−K_{P}(q−q_{g}) with saturation. The Drone was a custom-built racing drone with 6 degrees of freedom and 4 actuators. The state of the Drone (position, orientation and corresponding velocities) were measured by IMU and an OptiTrack motion capture system. State estimation and control action computation ran at 400 Hz. The safe velocity was commanded to the drone wirelessly from a desktop computer, while velocity tracking was performed using an on-board betaflight flight controller. The safe velocity was calculated with K_{P}=0.7 s⁻¹ and α=0.2 s⁻¹. FIG. 7 shows the Drone reaching the goal safely, as guaranteed by (15) since α was selected small enough for the available tracking performance. The value of α was chosen based on the simulated response of the single integrator. α was not tuned for optimal performance, and it could potentially be increased for less conservatism.

The Quadruped was a Unitree A1 quadrupedal robot, shown in FIG. 7, which has 18 degrees of freedom and 12 actuators. Its position was measured based on odometry assuming the feet do not slip, while joint states were available via built-in encoders. An ID-QP walking controller was realized at 1 kHz loop rate on this robot to track a stable walking gait with prescribed forward and lateral velocities and yaw rate. Individual commands were tracked via a motion primitive framework. In the single integrator experiments, the yaw rate was set to zero, while the safe velocity (49) with K_{P}=0.1 s⁻¹ and α=0.2 s⁻¹ was tracked by forward- and side-stepping. The Quadruped executed the task safely similar to the Drone, although it has fundamentally different dynamic behavior. This indicates the application-agnostic nature of model-free controllers implemented in accordance with various embodiments of the invention.

Finally, the unicycle model (20) and CBF (54) was also able to achieve safety on the Quadruped. The safe forward velocity and yaw rate in (55) were tracked by the same ID-QP walking controller. FIG. 7 shows the Quadruped traversing the obstacle course with Kᵥ=0.08 s⁻¹, K_{ω}=0.4 s⁻¹, α=0.2 s⁻¹, δ=0.5 m and R=0.5 m. While safety is maintained, the Quadruped performs the task with different behavior than in the previous experiment: it walks forward and turns instead of forward- and side-stepping.

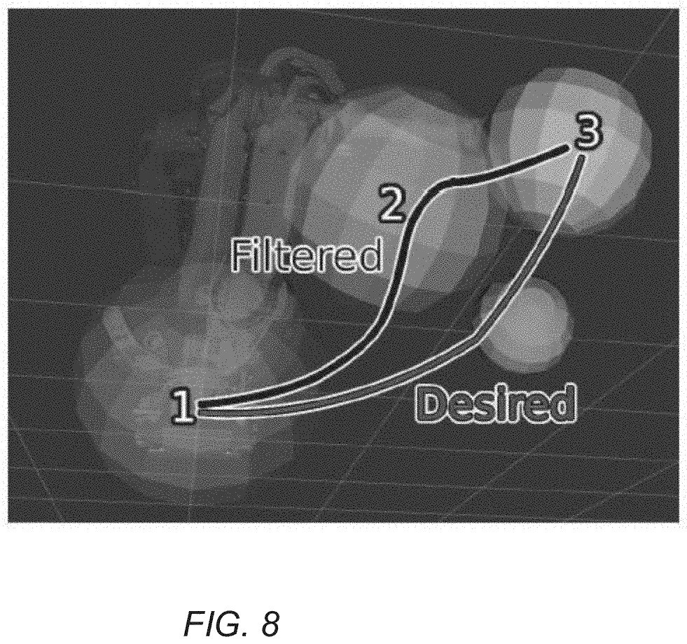

FIG. 8 illustrates a trajectory of robotic manipulator that is controlled based on a CBF in accordance with an embodiment of the invention. The robotic manipulator has 6-degrees-of-freedom manipulator (n=6) with a spherical tool attachment of radius r₁. The manipulator is designed to track a desired joint velocity v_{des}(q,t) while avoiding a spherical region centered at O∈ [symbol] ³ of radius r₂. The CBF can be written as the distance from the spherical tool to the sphere in the surroundings:

$$\begin{matrix}h ( q ) = {‖ F ( q ) - O ‖}_{2} - ( {r}_{1} + {r}_{2} ) \\ = \sqrt{{( {F}_{x} - {O}_{x} )}^{2} + {( {F}_{y} - {O}_{y} )}^{2} + {( {F}_{z} - {O}_{z} )}^{2}} - ( {r}_{1} + {r}_{2} )\end{matrix} \qquad ( 57 )$$

where F: [symbol] ⁶→ [symbol] ³ are the forward kinematics that give the position of the end-effector in space, (Fₓ, F_{y}, F_{z})=F(q). The gradient of the CBF can be computed as:

$$∇ h ( q ) = \frac{\partial h}{\partial F} \frac{\partial F}{\partial q} = {\frac{1}{{‖ F ( q ) - O ‖}_{2}} [ \begin{matrix}{F}_{x} - {O}_{x} \\ {F}_{y} - {O}_{y} \\ {F}_{z} - {O}_{z}\end{matrix} ]}^{T} J ( q ) , \qquad ( 58 )$$

where J:

$${ℝ}^{6} \to {ℝ}^{3} \times {ℝ}^{6} , J ( q ) = \frac{\partial F}{\partial q}$$

is the top three rows of the manipulator Jacobian. By solving the CBF quadratic program in (11), the robotic manipulator was able to achieve the safe path illustrated in FIG. 8.

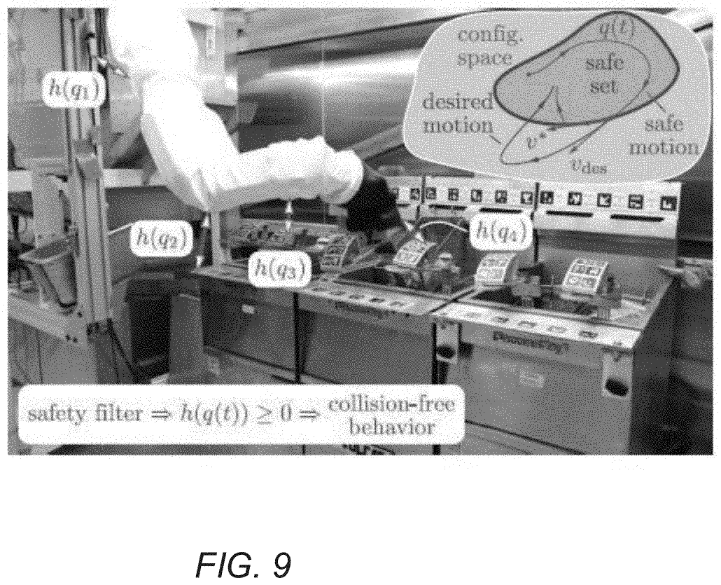

FIG. 9 illustrates an example implementation for controlling robotic manipulators in a cooking environment. With the knowledge of a reference trajectory, the quadratic programs (40) and (43) can be run in real-time paired with a desired joint velocity controller that tracks the reference trajectory. In many embodiments, this is achieved with a P controller to the next waypoint i:

v_{des}(q,t)=K_{P}(q_{des}ⁱ−q). (59)

In some embodiments, the error q_{des}ⁱ−q is heavily saturated to avoid large values of v_{des}(q,t) far from the goal. The tracked waypoint may be iterated forward when the robotic manipulator gets sufficiently close (∥q_{des}ⁱ−q∥₂<ϵ_{q}) or stuck (∥v_{des}(q,t)−\dot{q}∥₂>ϵᵥ for a certain amount of time).

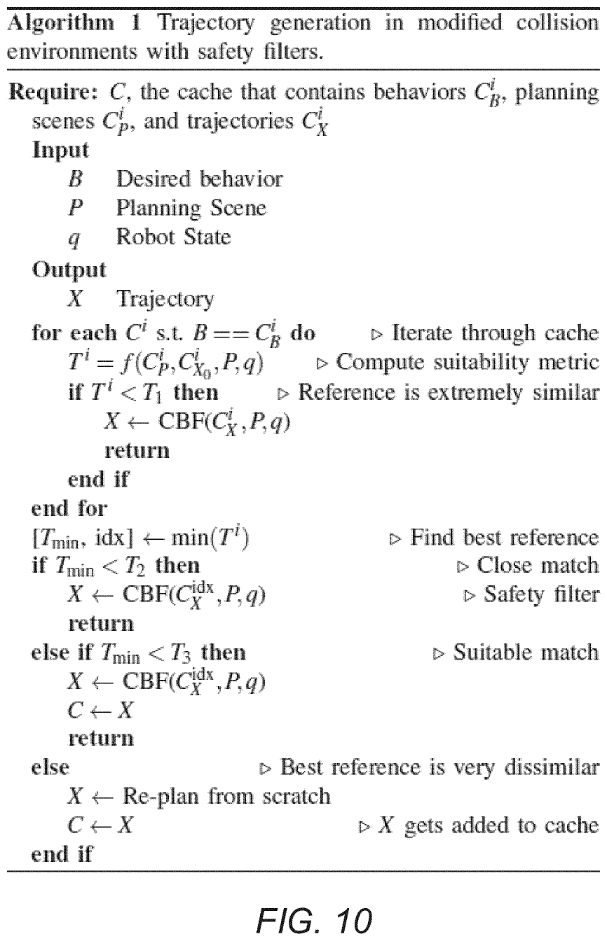

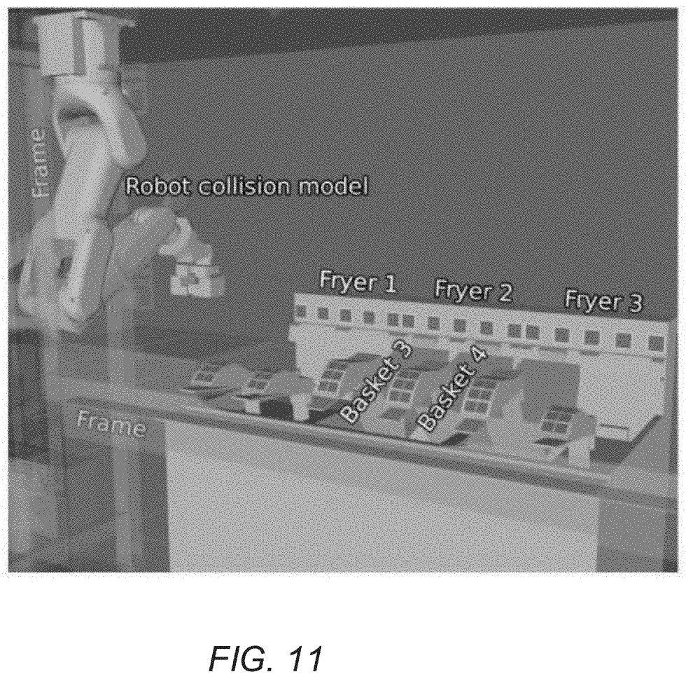

In practice, many industrial robotic manipulators can have large (˜200 ms) time delay during operation. In these situations, it may be desired to send pre-computed time-stamped trajectories, instead pf attempting to track a trajectory online with feedback. The basic algorithm for generating these safe trajectories, given a cache of previously computed reference trajectories, is detailed in FIG. 10. In numerous embodiments, the cache is filled with hand-picked trajectories that reach the goal, avoid obstacles, and are visually pleasing, as public perception of robotic manipulators matter.

In several embodiments, there are three fields of interest in the cached trajectories: the desired behavior B, the manipulator's trajectory T, and the collision environment used by a trajectory planner, referred to as the planning scene P. The algorithm can assess the suitability of previously computed trajectories in the cache with two major considerations: the difference in initial conditions and the similarity of the planning scene. The suitability of the i^{th} member of the cache Cⁱ can be evaluated by the function:

$${T}^{i} = f ( {C}_{P}^{i} , {C}_{{X}_{0}}^{i} , P , q ) = {δ}_{q}^{i} + {δ}_{P}^{i} , \qquad ( 60 )$$

$$where$$

$${δ}_{q}^{i} = {‖ {C}_{{X}_{0}}^{i} - q ‖}_{2} , {δ}_{P}^{i} = {\sum }_{o ∈ O} ‖ {C}_{{P}_{o}}^{i} - {P}_{o} ‖ \qquad ( 61 )$$

can assess the differences in the initial conditions of the robot and the collision objects o∈O making up the planning scene.

In some embodiments, the suitability metric has three threshold values (T₁, T₂ and T₃). If Tⁱ<T₁, then the search stops, as the trajectory in the cache is so close that it is not worth searching, and the CBF filter is applied. After searching through all cache members, if Tⁱ<T₂, then the filter is applied, but the trajectory is not added to the cache to prevent, it from growing unnecessarily large. If T₂<Tⁱ<T₃, then the filter is applied and the resulting trajectory is added to the cache. Finally, if Tⁱ>T₃, then the original motion planning algorithm is used, and the result is added to the cache. To obtain the joint trajectory X via the CBF, a trajectory tracking controller like (59) may be utilized along with the CBF quadratic program, and integrate its solution throughout the behavior.

FIG. 11 illustrates a simulated cooking environment where a robotic manipulator is controlled by a model-free safety controller in accordance with an embodiment of the invention. The robot and obstacle representations are a series of meshes described by Universal Robot Description Format (URDF) and Semantic Robot Description Format (SRDF) files. The position and orientation of objects are updated before each planning attempt. To implement the CBF filter, the signed distance to the obstacles and other links sd(q), the normal vectors corresponding to the points with minimal signed distance \hat{n}(q), and the manipulator Jacobian at these points J(q) need to be computed.

The MoveIt framework which is an open-source robotics software package for motion planning, is able to compute all three of these values. Specifically, the distanceRobot( ) and distanceSelf( ) functions of the CollisionEnv class provide the signed distances and normal vectors needed for environmental and self-collisions. Moreover, the getJacobian( ) function in the RobotState class returns the manipulator Jacobian. Thus, no other external libraries are required to implement this algorithm. Once the three values are computed, the Operator Splitting Quadratic Program (OSQP) quadratic program solver may be used to calculate the safe velocity commands, and integration can be done manually.

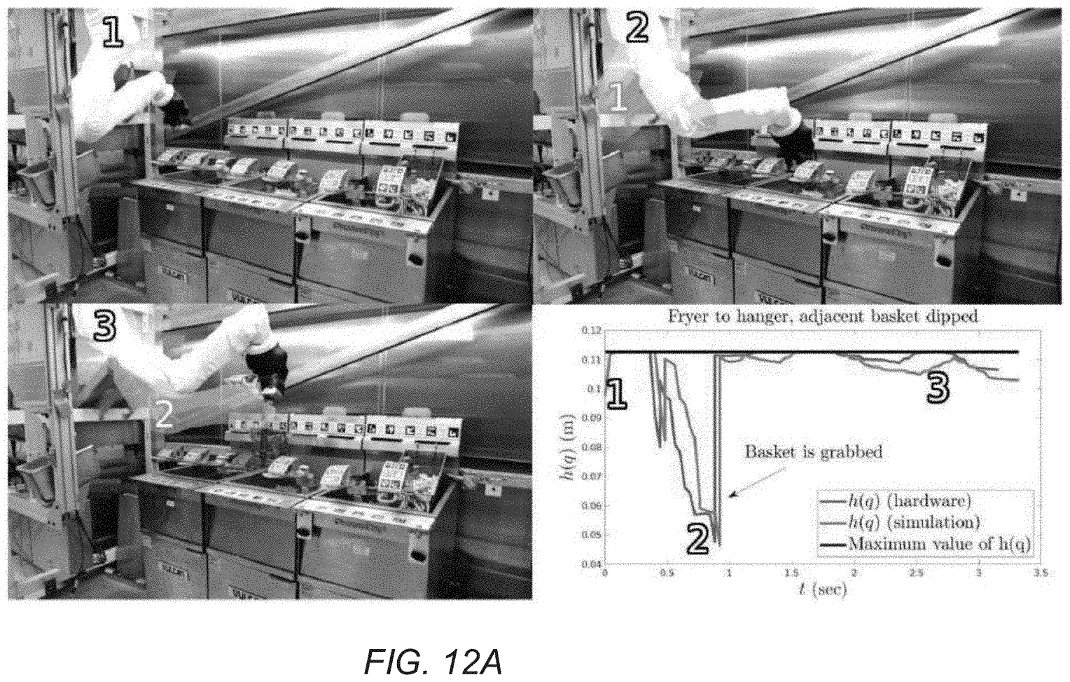

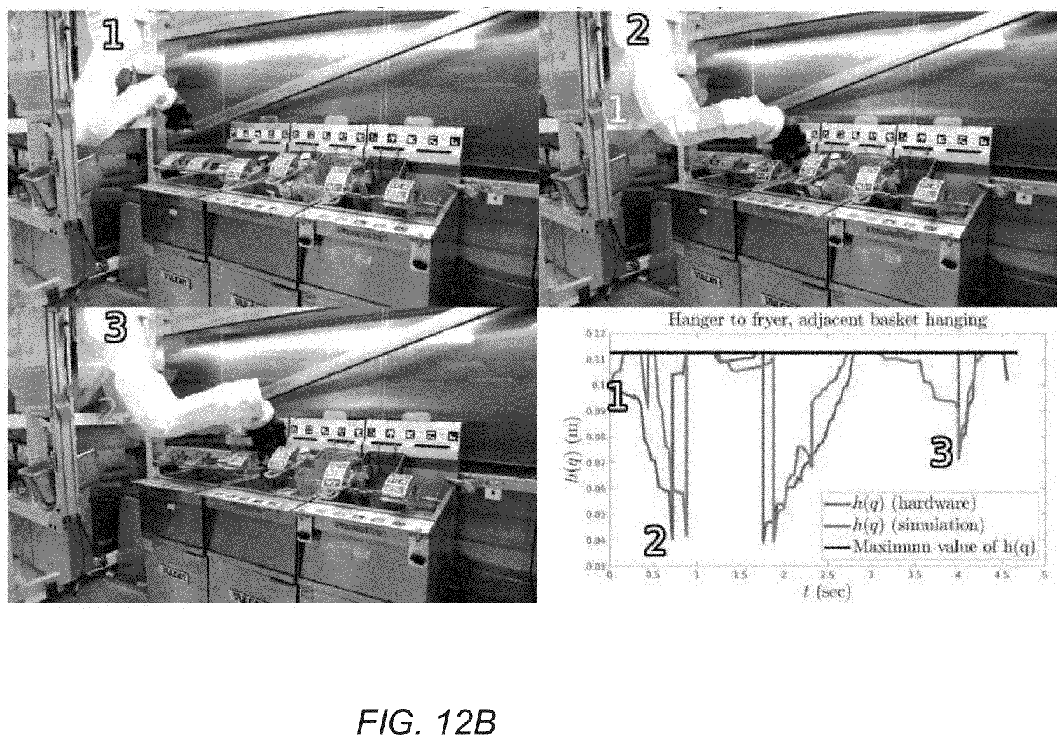

FIGS. 12A-B illustrates hardware trajectory testing results of a robotic manipulator controlled by a model-free safety controller in accordance with an embodiment of the invention in a cooking environment. The example robotic manipulator is a FANUC LIR Mate 200iD)/7LC robotic manipulator wrapped in a sleeve, and joint trajectories were sent from an Intel i9-9900KF running ROS.

The cooking environment used in the testing is fully modeled using high-quality meshes used for collision checking. There are 36 collision objects in total, each represented by tens to hundreds of mesh triangles. The primary collision objects of concern are the six baskets, three industrial fryers, the hood vent over the fryers, and the glass pane separating the manipulator from the human workers. Of these objects, the baskets and fryers are the most commonly displaced. As shown in the figures, the workspace of the manipulator is very densely crowded with obstacles. To complete a behavior, it is common to have less than a few centimeters of clearance between the robot and the surrounding environment. For this reason, planning methods must be minimally conservative, and there is no room for any collision buffer.

For experiments, a minimal cache was utilized to highlight the role of CBFs in re-planning around obstacles. In a commercial setting, with a more populated cache, the CBF would have many more prior trajectories to choose from, meaning that the path modifications would be much smaller. In practice, we find that the cache size saturates at around 200 stored behaviors, and we used roughly 10% of that. The method's ability to safely re-plan on the two most volatile behaviors: fryer_to_hanger and hanger_to_fryer were tested. In several embodiments, these behaviors see the most change in obstacle position and initial conditions, and are the most commonly re-planned behavior.

The fryer_to_hanger behavior illustrated in FIG. 12A moves a basket from the dipped state to the hanging state. The manipulator picks up a basket that has finished cooking and hangs it, allowing the oil to drip off the basket before serving. The hanger_to_fryer behavior illustrated in FIG. 12B is the reverse of fryer_to_hanger, transitioning a basket from the hanging state to the frying state. Each behavior is tested in two primary configurations: one where the adjacent basket is submerged, and one where it is hanging. For the purpose of this paper, each of the four testing configurations were run 25 times, each with different cached trajectories and planning environments, for 100 total executions. The testing methodology was simple: for each setup, we first run the CBF on the best matching reference trajectory in the limited cache, and then we re-plan using TrajOpt for comparison purposes. Along with the true noise of the localization of the robot and environment, small amounts (several mm) of noise was further injected into the initial conditions and obstacles to ensure that the new trajectory differed significantly from the cache.

The controller was able to produce a successful, collision-free trajectory in all 100 cases, even with the artificially limited cache size. The average computation time per CBF call was 2 iris, and the average computation time for the entire behavior was 223 ms. This is a significant improvement compared to TrajOpt's average computation time of 5923 ms. The CBF's trajectory computes waypoints every 10 ms compared to TrajOpt's 64 ms, thus no additional local planner needs to be used.

Although specific methods of model-free control of robotics platforms are discussed above, many different methods of model-free control of robotics platforms can be implemented in accordance with many different embodiments of the invention. It is therefore to be understood that the present invention may be practiced in ways other than specifically described, without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A robot, comprising:
a set of one or more actuators;
at least one sensor; and
a controller comprising a set of one or more processors and a memory containing a controller application, wherein the controller application configures the set of processors to control the robot by performing the steps of:
defining a safe set identifying positions where the robot is safe;
determining a control barrier function (CBF) based on the safe set;
computing a safe velocity based on the CBF and a current position of the robot such that the robot remains in the safe set; and
instructing the robot to track to the safe velocity.

2. The robot of claim 1, wherein the computing of the safe velocity and instructing the actuators to track to the safe velocity are repeated until the robot reaches a target.

3. The robot of claim 1, wherein computing the safe velocity comprises compute a new safe velocity when the sensor indicates that the robot is approaching a boundary of the safe set, such that the velocity is unsafe.

4. The robot of claim 1, wherein the safe set is defined in a configuration space.

5. The robot of claim 1, wherein the CBF is based on a reduced-order dynamical model of the robot.

6. The robot of claim 1, wherein the safe velocity is tracked at a rate higher than the rate at which the robot approaches a boundary of the safe set.

7. The robot of claim 1, wherein tracking the safe velocity is exponentially stable.

8. The robot of claim 1, wherein tracking the safe velocity is input-to-state stable.

9. The robot of claim 8, wherein the stability of the tracking satisfies control Lyapunov functions (CLFs).

10. The robot of claim 1, wherein instructing the robot to track to the safe velocity comprises directing the set of one or more actuators to spin at a rate that drives the robot to track to the safe velocity.

11. The robot of claim 1, wherein the controller is further configured to define a modified safe set based on CLFs.

12. The robot of claim 1, wherein computing the safe velocity further comprises adjusting for errors in continuous approximations of distances.

13. A method for model-free safe control of robotics platforms comprising:
defining a safe set that represents positions where the platform is safe;
determining a control barrier function (CBF) based on the safe set;
computing a safe velocity based on the CBF and a current position of the platform such that the platform remains in the safe set; and
instructing the platform to track to the safe velocity.

14. The method of claim 13, the computing of the safe velocity and instructing a set of one or more actuators to track to the safe velocity are repeated until the platform reaches a target.

15. The method of claim 13, wherein computing the safe velocity comprises compute a new safe velocity when a sensor indicates that the platform is approaching a boundary of the safe set such that the velocity is unsafe.

16. The method of claim 13, wherein the safe set is defined in a configuration space.

17. The method of claim 13, wherein the CBF is based on a reduced-order dynamical model of the platform.

18. The method of claim 13, wherein the safe velocity is tracked at a rate higher than the rate at which the platform approaches a boundary of the safe set.

19. The method of claim 13, wherein tracking the safe velocity is exponentially stable.

20. The method of claim 13, wherein tracking the safe velocity is input-to-state stable.

21. The method of claim 20, wherein the stability of the tracking satisfies control Lyapunov functions (CLFs).

22. The method of claim 13, wherein instructing the platform to track to the safe velocity comprises directing a set of one or more actuators to spin at a rate that drives the platform to track to track to the safe velocity.

23. The method of claim 13, further comprising defining a modified safe set based on CLFs.

24. The method of claim 13, wherein computing the safe velocity further comprises adjusting for errors in continuous approximations of distances.
